(19) United States
(12) Patent Application Publication
(10) Pub. No.: US 2015/0317719 A1
(43) Pub. Date: Nov. 5, 2015

(54) DETERMINING CUSTOMER INTENT IN AN ONLINE RETAIL ENVIRONMENT

(71) Applicant: TrackIF LLC, Minnetonka, MN (US)

(72) Inventors: Doug Berg, Excelsior, MN (US); Eric Caron, Eden Prairie, MN (US)

(73) Assignee: TrackIF LLC, Minnetonka, MN (US)

(21) Appl. No.: 14/268,406

(22) Filed: May 2, 2014

(51) Int. Cl. G06Q 30/06

(52) U.S. Cl. CPC G06Q 30/0633

(57) ABSTRACT

One embodiment of the present invention pertains to a method for receiving information about customer intent in an online retail environment. The method includes providing a user interface where the customer can select products of interest to add to a watchlist. Further, with respect to each of the items in their watchlist, the customer can also set conditions for future notifications, including but not limited to a decrease in price or a free shipping offer or stock availability.

### BACKGROUND

Online shopping environments currently provide many different ways to bring customers and retailers together. However, one of the problems still facing retailers in the online space is a lack of insight into what their customers want. One of the biggest challenges in particular is understanding customer intent. This lack of understanding is evidenced by a common conversion rate of as little as 2%. More insight into the intent of would-be purchasers is greatly desired by retailers. Getting information about why shoppers do not make a purchase after browsing a retailer's website would allow retailers to provide targeted advertising to better increase conversion rates and deepen customer loyalty.

The challenge of understanding customer intent is compounded by the fact that the state of mind of the average customer can change quickly. For example, in the post-recession retail space, many customers are searching not just for a good price, but for a perceived deal on the products they want. Further, many customers are now more willing than ever to compare prices between retailers. Online retail customers are increasingly interested in information on sales and price reductions on the products they are looking to purchase.

Consumers and retailers alike would benefit from mechanisms that provide improved commercial flexibility in the online space. One of the biggest sets of tools that customers are lacking in the current online retail space is an adequate means for setting alerts and notifications for when the products they want to purchase reach the right conditions for purchasing. The right conditions for purchasing may include a free shipping offer or a sale. The right conditions may also include the price being reduced from when the customer last viewed the item, or the price reduced below a certain threshold. Additionally, the customer may want an alert as to when the item is back in stock.

The current strategies for retailers to reach consumers involve advertisements based on previous purchases and browsing histories as well as mass-communicated advertisements through e-mail. However, this often falls short of giving customers the information or offers they truly want in order to make their purchasing decisions on specific products of interest. Often, customers are specifically looking for price reductions, sales, free shipping or other deals. Additionally, customers may want notifications for when a product comes back in stock.

One tool that does exist presently in the online retail space is the wishlist—a list where would-be customers can keep track of items they may wish to purchase in the future. However, wishlists are site-specific, requiring a customer to create an account at every website where they wish to keep track of items they may purchase in the future. For retailers, the wishlist feature gives an idea of what customers are interested in purchasing, but provides no way to capture the criteria of interest that would increase the likelihood of any shopper to purchase the product of interest. Further, the wishlist feature does not provide any automated method for notifying the customer of changes associated with any product of interest such as price change or special offer notifications when such an event occurs on the retailer's website. no further insight into what type of sale or promotion will entice prospective customers to complete their purchase.

### SUMMARY

One embodiment of the present invention pertains to a method for receiving information about customer intent in an online retail environment. The method includes providing a user interface where the customer can select products of interest to add to a watchlist. Further, with respect to each of the items in their watchlist, the customer can also set conditions for future notifications, including but not limited to a decrease in price or a free shipping offer or stock availability.

In another embodiment, the present invention pertains to a means for tailoring advertisement campaigns to take advantage of collected information about customer intent concerning products in a retailer's product database.

### BRIEF DESCRIPTION OF THE DRAWINGS

FIG. 1 is a block diagram of a transaction facilitation service provider in a network architecture in accordance with an embodiment of the present invention.

FIG. 2 is a flow diagram of the interactions between a customer-client and a transaction facilitation service provider in accordance with an embodiment of the present invention.

FIG. 3A-C are screen shots of a customer-client adding an item to their watchlist and setting conditions for a future notification in accordance with an embodiment of the present invention.

FIG. 4 is a screenshot of a customer-client's watchlist in accordance with an embodiment of the present invention.

FIG. 5 is a screenshot of an item in a customer-client's watchlist in accordance with an embodiment of the present invention.

FIG. 6 is a block diagram of a transaction facilitation service provider in a network architecture in accordance with an embodiment of the present invention.

FIG. 7 is a flow diagram of the interactions between a retailer client and a transaction facilitation service provider in accordance with an embodiment of the present invention.

FIG. 8 is a screenshot of a login structure for a retailer client in accordance with an embodiment of the present invention.

FIG. 9A-G are screenshots of a dashboard for a retailer client in accordance with an embodiment of the present invention.

### DETAILED DESCRIPTION

### Customer Architecture

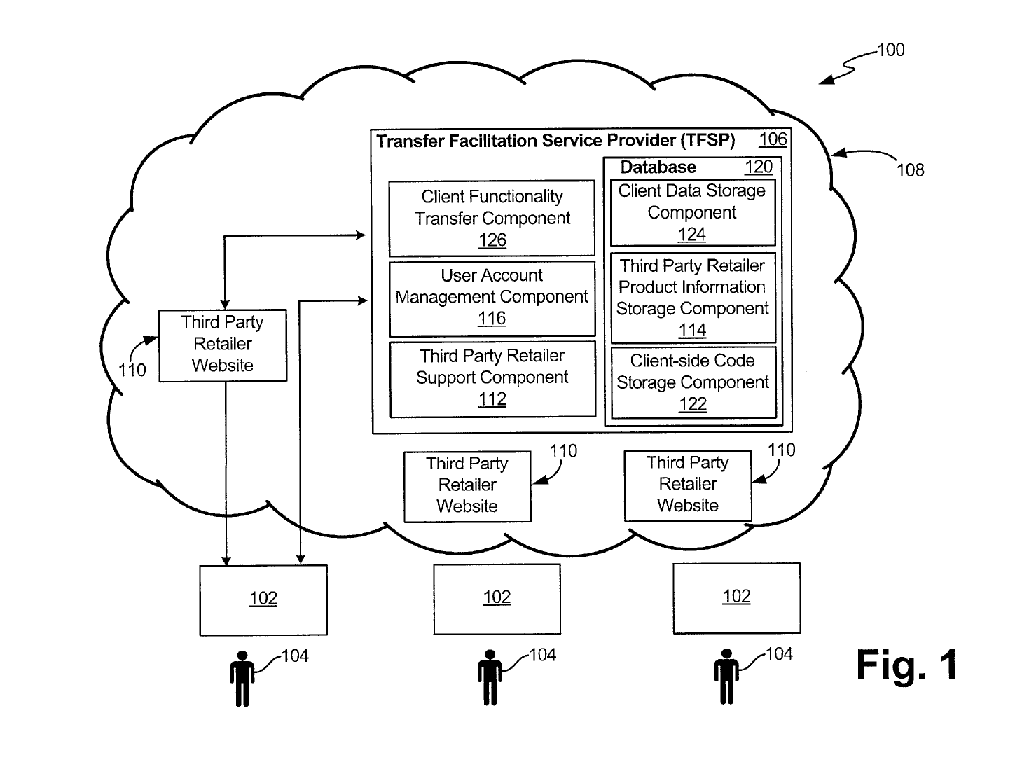

FIG. 1 is a block diagram of an online retail environment 100 in which embodiments of the present invention are useful. A plurality of customer-clients 104 operate a plurality of corresponding devices 102 in the online retail environment 100. In one embodiment, the device 102 is a computing device with a browser. The customer-clients 104 interact with a transaction facilitation service provider 106 within a network 108. FIG. 1 shows the transaction facilitation service provider 106 operating within the network 108, but the transaction facilitation service provider 106 could, in another embodiment, operate outside of the network 108. The transaction facilitation service provider 106, in turn, interacts with third party retailer websites 110, through the third party retailer support component 112, storing information on individual products offered by the retailer in the third party retailer product information storage component 114, housed within the database 120. In one embodiment, the database 120 is operates in connection with a cloud-based network structure. As shown in FIG. 1, the customer-clients 104 interact directly with the transaction facilitation service provider 106 and also interact with the transaction facilitation service provider 106 through the third party retailer websites 110. The transaction facilitation service provider 106 has a database 120 with several storage components, including a client-side code storage component 122, a client data storage component 124, and a third party retailer product information storage component 114.

In addition to the database 120, the transaction facilitation service provider 106 also has a client functionality transfer component 126, through which the customer-client 104 accesses the client-side code storage component 122. The transaction facilitation service provider 106 also has a user account management component 116, through which the customer-client 104 sets up an account with the transaction facilitation service provider 106.

The transaction facilitation service provider 106 also includes a third party retailer support component 112. The third party retailer support component 112 facilitates collection of information on products sold by third party retailers on their websites 110, which information is stored in the third party retailer product information storage component 114 of the database 120. The transaction facilitation service provider 106 collects information on each of the products sold by a third party retailer on their website 110.

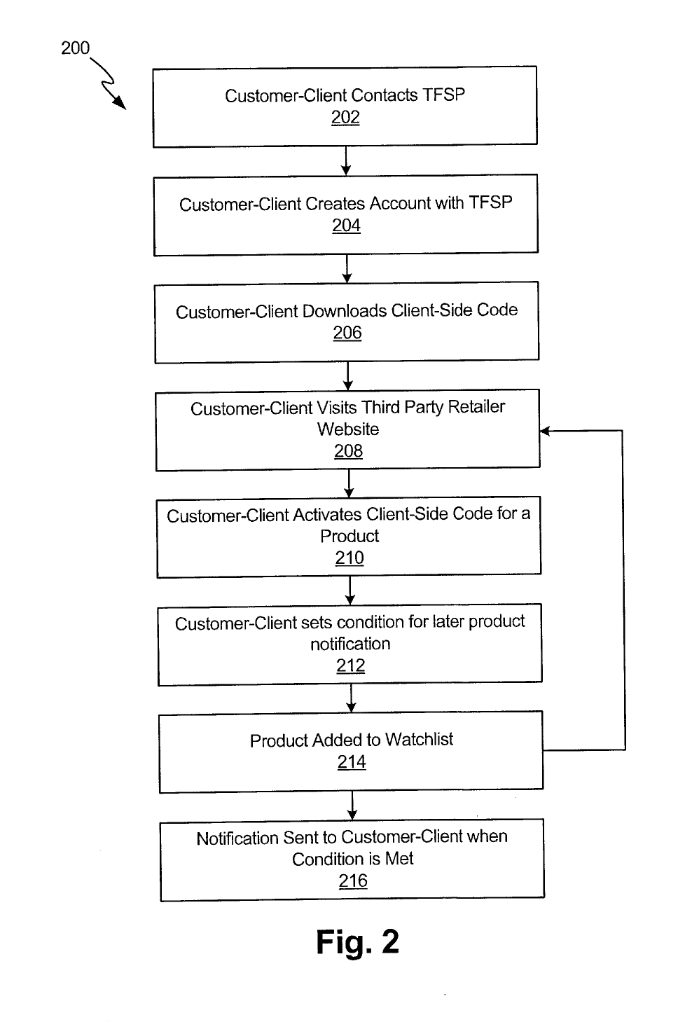

In one embodiment, shown in greater detail FIG. 2, in block 202, the customer-client 104 first interacts with the transaction facilitation service provider 106. The customer-client 104 then, in block 204, creates an account with the user account management component 116. In block 206, the customer-client 104 downloads the client-side code from the client-side code storage component 122 within the database 120. In one embodiment, the client-side code is a browser plug-in.

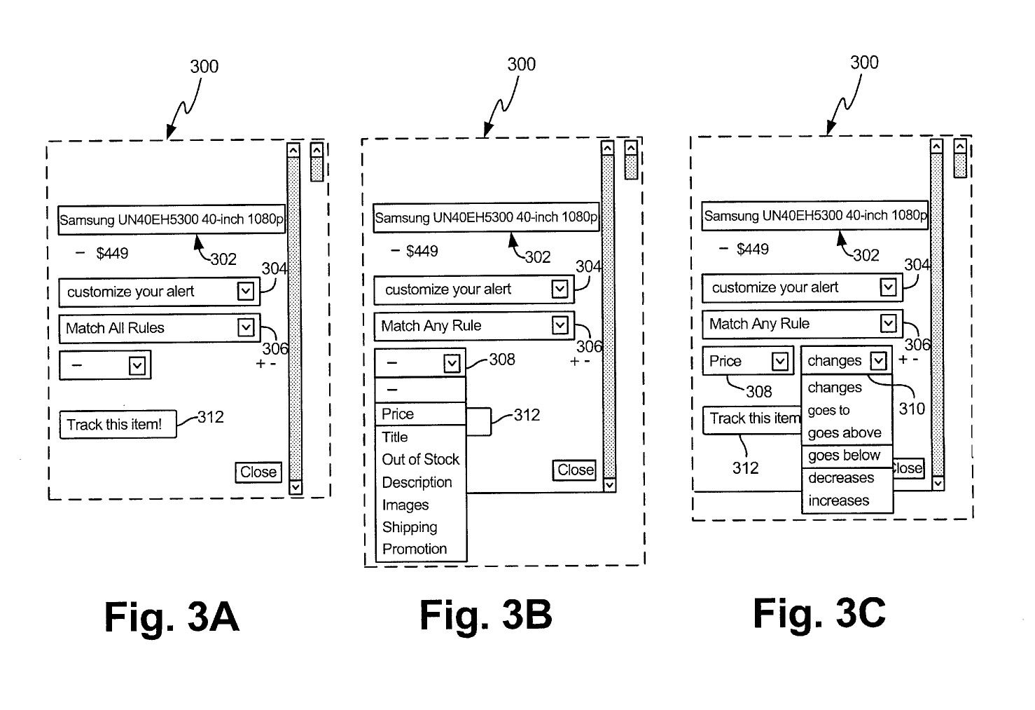

In block 208, the customer-client 104 then interacts with a third party retailer website 110. In block 210, the customer-client 104 can choose to activate the client-side code with respect to a product of interest, as described in further detail with respect to FIG. 3. Any interaction with the product of interest with the client-side code activated is stored by the transaction facilitation service provider 106 in the client data storage component 124 of the database 120.

After activating the client side code with respect to a product of interest, the customer-client 104 can then access the browser plug-in from any one of a plurality of third party retailer websites 110 supported by the transaction facilitation service provider 106. Support by the transaction facilitation service provider 106 includes, in one embodiment, the transaction facilitation service provider 106 storing, in the third party retailer product information storage component 114, information on the products offered by the third party retailer on their website 110. The transaction facilitation service provider 106 obtains the product information, in one embodiment, by reading the HTML code of a website for tags indicating key terms relating to the product—for example, the title, the current price, the shipping charge, and whether the item is in stock currently.

When the customer-client 104 activates the client-side code with respect to a product of interest, the transaction facilitation service provider 106 finds the matching product in the third party product information storage component 114. In block 212, the transaction facilitation service provider 106 gives the customer-client 104 an option to add the item to their watchlist and sets a condition to trigger a future notification to the customer client 104 when the condition is met. Once the condition is set, in block 214, the item is added to the customer-client's 104 watchlist. The process in blocks 208-214 repeats anytime the customer-client 104 activates the client-side code with respect to a new product of interest. Finally, in block 216, the customer-client receives an alert when the condition set in block 212 is met.

When the customer-client 104 visits a third party retailer's website 110 and finds a product of interest, the customer-client 104 can activate the plug-in, in one embodiment by clicking on an icon. Once activated, the plug-in allows the customer-client 104 to add the product of interest to their watchlist. Additionally, the customer-client 104 can associate a condition with the product of interest added to the watchlist. For example, in one embodiment, the customer-client can request a notification if the price of the product of interest decreases. In one embodiment, the notification can be delivered by e-mail to the customer-client 104. However, a customer-client 104 can also add a product of interest to their watchlist without setting a condition for notification.

When the condition set by the customer-client 104 for a specific product of interest is met, the transaction facilitation service provider 106 sends a notification to the customer-client 104 that the condition has been met. For example, in one embodiment, the customer-client 104 is interested in purchasing a new television set and starts shopping in November. Knowing that the holiday retail season is fast approaching, the customer-client 104 wants to wait and see if the price will decrease. While viewing the television set of interest, the customer-client 104 can activate the client-side code. Upon activation, the customer-client 104 has an option to set a condition for delivery of a later notification. The customer-client 104 could, in one embodiment, request a notification if the price of the television set decreases by any amount. Additionally, the customer-client can request a notification if the price of the television set decreases to (or lower than) a specified amount. Alternatively, as television sets are large and can be costly to ship, the customer-client 104 could set a condition for a notification of free shipping or a reduced price on shipping. By setting a condition on the television set, the television set is then added to the customer-client's 104 watchlist. The transaction facilitation service provider 106 then monitors the item. When the condition set by the customer-client 104 is met, the transaction facilitation service provider 106 generates and sends a notification, an e-mail in one embodiment, to the customer-client 104 indicating that the condition has been met. In one embodiment, the notification also includes a means for the customer-client 104 to return to the third party retailer's website 110 and purchase the item. In a preferred embodiment, the transaction facilitation service provider 106 sends an e-mail notification with a hyperlink back to the third party retailer's website 110.

FIGS. 3A-C detail an exemplary process by which a customer-client 104 sets a condition on a product of interest and an exemplary series of conditions the customer-client 104 can select as a basis for notifications about the product of interest. In one embodiment, the customer-client 104 can add a product of interest to their watchlist without any conditions set for alerts. FIG. 3A shows a selected product of interest 300, selected by the customer-client 104 while browsing the third party retailer's website 110 and activating the client-side code. The activated client-side code shows the product name 302 and current price. Additionally, the activated client-side code displays a condition setting mechanism 304. Selecting the condition setting mechanism 304 directs the customer-client 104 to a condition selector 306. The condition selector 306 directs the customer-client 104 to select either to trigger a notification upon one condition matching or a plurality of conditions matching. The customer-client 104 is then directed to the condition type selector 308 wherein the customer-client 104 selects the basis for a condition—e.g. price. Then, the customer-client 104 is directed to the condition trigger selector 310, wherein the customer-client 104 clarifies exactly what triggers a notification—for example that the price must decrease in order for a notification to be sent. Finally, the customer-client 104 selects to add the item to their watchlist by selecting the add to watchlist icon 312.

In another embodiment, the customer-client 104 can add the product of interest to their watchlist with a reminder to purchase later. In a further embodiment, the customer-client 104 can set a specific condition based on a change in price, title, out of stock status, description, images, shipping, or promotion. These changes may include the price changing, reaching a set amount, going above a set amount, going below a set amount, decreasing from an amount at the time the condition is set, or increasing from an amount at the time the condition is set. In an additional embodiment, the customer-client 104 can set multiple conditions that need to be met in order for an alert to be sent. For example, the customer-client 104 could require the price to decrease and the shipping to decrease to free. In another example, the customer-client 104 could require the product to come back into stock and for a promotion to be available on the product of interest, as shown in FIG. 3C.

FIGS. 3A-C will now be described in further detail with respect to the exemplary customer-client 104 searching for a television set for a holiday purchase. FIGS. 3A-C depict the process whereby the exemplary consumer-client 104 sets a specific condition for later notification on a television set the consumer-client 104 is interested in purchasing. FIG. 3A shows a portion of a screen depicting the client-side code activated. In FIG. 3A, the customer-client 104 has selected a specific television set as a product of interest. When activated, the client-side code shows the name of the product and the current price, and gives the customer-client 104 a choice to add the item to a watchlist as well as options for setting a notification. In FIG. 3B, the customer-client 104 has selected to set a specific condition for a later notification. However, this is not to say that the customer-client 104 could not add the item to the watchlist without setting a condition, or that the customer-client 104 could not add the item to the watchlist with a general reminder to purchase the product of interest. In FIG. 3C, the customer-client 104 has selected to set a condition for a notification based on a change in price of the television set. FIGS. 3A-C show the customer-client 104 setting a single condition for a notification, however in another embodiment the customer-client 104 can set multiple conditions through the condition selector 306. As shown in FIGS. 3A-C, in addition to setting a series of conditions for a notification, the customer-client 104 can have the transaction facilitation service provider 106 send a notification when any of the conditions are met, or the customer-client 104 can require all conditions be met before a notification is sent.

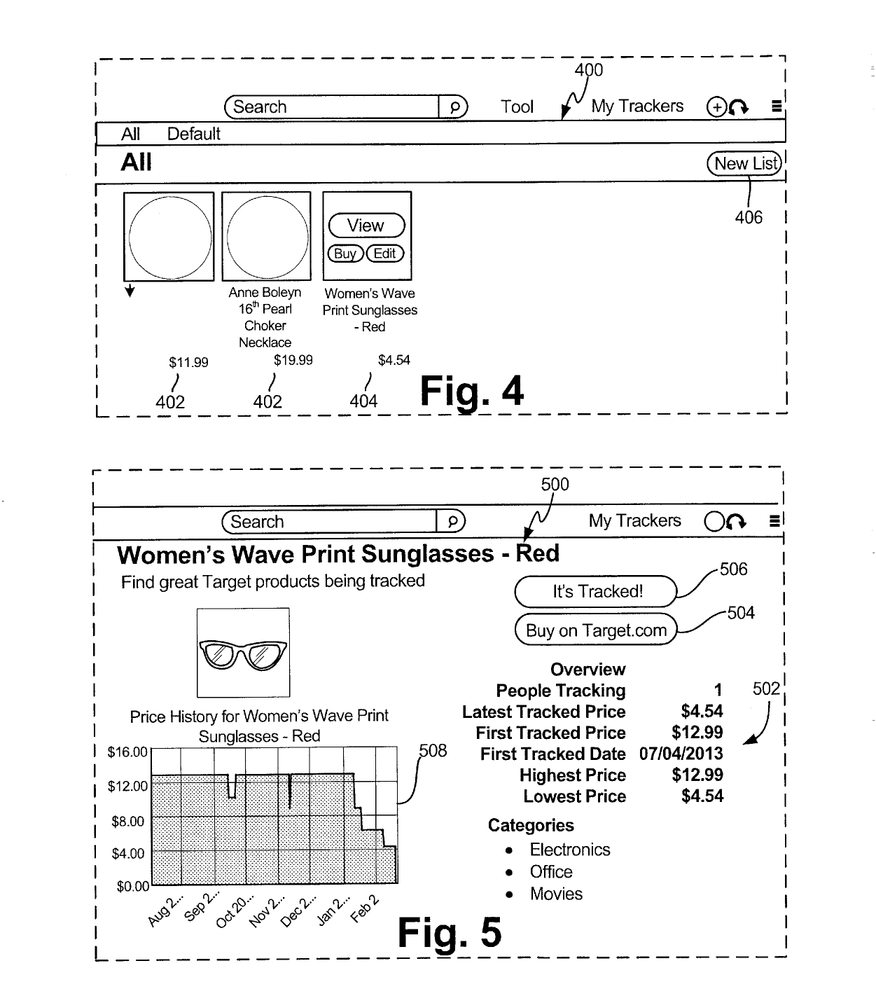

Once the customer-client 104 sets a condition for future notification, the television set is added to their watchlist. The customer-client 104 can view their watchlist, as shown in FIG. 4, on a watchlist platform 400 hosted by the transaction facilitation service provider 106. In one embodiment, the watchlist platform 400 includes a website using a browser. The customer-client 104 can separate the items in their watchlist platform 400 into a series of watchlists as desired. For example, the customer-client 106 could add the television set to a watchlist that only includes television sets that are of interest to the customer-client 106. The watchlist platform 400 shows a series of watchlist items 402. Additionally, the customer-client 104 can take further action with respect to a selected watchlist item 404, such as purchasing the television set in the watchlist or changing the conditions set on the television set, as indicated in FIG. 4. Additionally, the customer-client 104 can create a series of watchlists using the create a new watchlist button 406.

Within the watchlist platform 400 hosted by the transaction facilitation provider 106, the customer-client 104 can view the conditions set on each of the products of interest, and, additionally, the customer-client 104 can edit the conditions set on any of the products of interest in the watchlist. Additionally, through the watchlist platform 400, the customer-client 104 can activate one of the items in the watchlist platform 400, as illustrated, in FIG. 4, in which the third item in the watchlist platform 400 is a selected watchlist item 404. In one embodiment, the selected watchlist item 404 is activated by the customer-client 104 cursor hovering over the a watchlist item 402 with an input device, such as a mouse or a trackpad. In another embodiment, the customer-client 104 needs to select the watchlist item 402 using an input device such as a mouse or a trackpad. Upon selection, the customer-client 104 can choose to edit the conditions that must be met for an notification to be generated on the selected watchlist item 404. Additionally, the customer-client 104 purchase the product of interest. In one embodiment, selecting to purchase the product of interest takes the customer-client 104 to the third party retailer's website 110 where the item was added to the watchlist. Further, the customer-client 104 can choose to view further details about the selected watchlist item 404 on the watchlist platform 400 hosted by the transaction facilitation service provider 106.

FIG. 5 is a screenshot of a watchlist item product view 500 of the selected watchlist item 404 on the watchlist platform 400 hosted by the transaction facilitation service provider 106. In one embodiment the watchlist platform 400 is a web server component accessed by a browser that the customer-client 104 navigates using the network 108. The watchlist item product view 500 illustratively includes product tracker analytics 502. Additionally, the watchlist item product view 500 also includes a buy on retailer website button 504. The watchlist item product view 500 also includes a track status indicator 506. In one embodiment, the customer-client 104 can also see a price history 508 of the product of interest since the date it was added to the watchlist, detailing the changes in price. The price history 508 is presented graphically or in any other suitable fashion. Additionally, the customer-client 104 can see other product analytics 502 concerning the product since it was added to the watchlist. In one embodiment, as shown in FIG. 5, the product tracker analytics 502 include the total number of conditions set by a plurality of customer-clients 104 of the transaction facilitation service provider 106 that concern the product of interest as well as the current price, the price when the item was first added to the watchlist, the date when the item was added to the watchlist, as well as the highest and lowest price of the product of interest since it was added to the watchlist. In an additional embodiment, the customer-client 104 can see the categories under which the third party retailer classifies the selected watchlist item 404.

The transaction facilitation service provider 106 connect a unique set of data on a person (the customer-client 104), a product (the product of interest) and the intent (memorialized in the form of the conditions for future notifications). This information on the person, product and intent, or PPI data, is then compared against a database of similar information to determine historical trends and project future trends. In one embodiment, the transaction facilitation service provider 106 may be able to use those historical trends to provide insight to customer-clients 104. For an example, if the transaction facilitation service provider 106 detects that a certain retailer has a history of reducing prices on Thursdays, it can indicate to a customer-client 104 looking to purchase an item from that retailer on a Wednesday that it might be better to wait until Thursday for a potential discount. Additionally, in another embodiment, if the transaction facilitation service provider 106 detects that a certain product is at a lowest price in its price history 508, the transaction facilitation service provider might indicate to a customer-client 104 that it is a good time to purchase the product and that further deals may be unlikely. The examples provided here are not intended as exemplary embodiments only and are not intended to limit the uses of the PPI data by the transaction facilitation service provider 106 on behalf of its customer-clients 104.

The PPI data allows the transaction facilitation service provider 106 to match customer-clients 104 with the products they want, and at the conditions matching their intent to purchase. Additionally, the PPI data allows the transaction facilitation service provider 106 to provide to interested retail outlets information on a set of online shoppers interested in a specific product, and the conditions that those persons have indicated would trigger a purchase. The PPI information, thus, connects online shoppers and retailers in a way that has not been available in the past. With the PPI information, the transaction facilitation service provider 106 can filter all of the watchlist items for all of its customer-clients 104 by any two of the PPI categories.

For example, the transaction facilitation service provider 106 may be providing services for a specific retailer, Gucci. The transaction facilitation service provider 106 can provide, for Gucci, a list of customer-clients 104 that are searching for a specific Gucci purse, and have set a condition requesting a notification when that specific Gucci purse is available with free shipping. In this example, the product would be the specific Gucci purse, the intent would be purchase when shipping is free, and the people would be the customer-clients 104 that are returned by the filter.

Additionally, Gucci could request information on a specific set of people, for example those that recently became a customer-client 104, and a specific product, for example a recently launched handbag that is not selling well. The transaction facilitation service provider 106 could filter by recent accounts created and the particular handbag and provide Gucci with insight into the why the product is not selling well. For example, a series of customers may have indicated that they would purchase if the price of the specific handbag dropped by 10%, or that they would purchase if Gucci offered free shipping with the purchase of that handbag.

Further, Gucci could be interested in a series of products that online shoppers might purchase if offered a specific intent. Gucci could request that the transaction facilitation service provider 106 filter by a set of customer-clients 104, for example recent accounts created, and a specific intent, for example a notification that of purchase intent when the item is back in stock. This would give Gucci an indication of the items that customers are most interested in purchasing, for example when they are back in stock.

The examples provided above are merely exemplary and are not meant to limit the types of people, product, or intent filters, or combinations of filters, which the transaction facilitation service provider 106 could use to provide insight to a retailer about the intent of online shoppers.

### Retailer Architecture

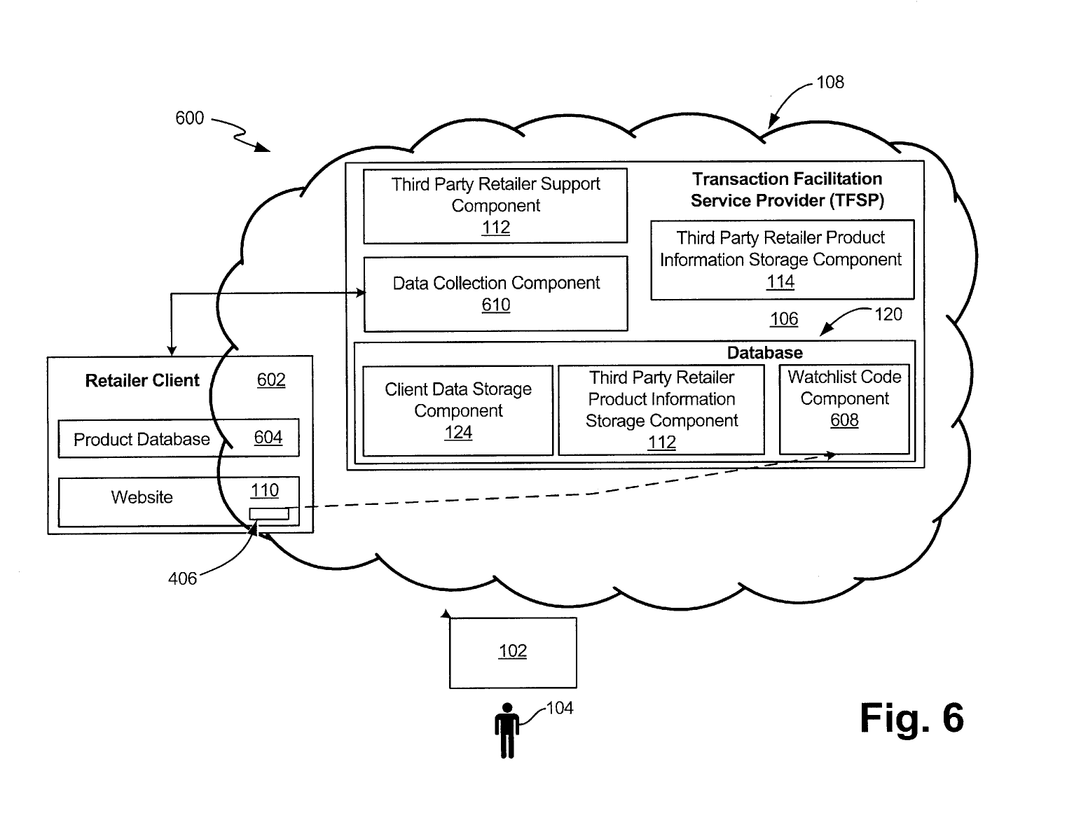

In FIG. 6, the transaction facilitation service provider 106 is shown providing analytic services and content to a retailer client 602 through a retailer network architecture 600. As part of the content provided, the transaction facilitation service provider 106 provides, in one embodiment, the code to support a watchlist button on the retailer client's 602 website. The code is provided by a watchlist code component 608. The retailer client's 602 website is supported by the third party retailer product information database 114. As noted above with respect to the online retail environment 100, in one embodiment the third party retailer product information storage component 114 collects and tracks product information from the retailer client's 602 website for the benefit of its customer-clients 104. However, in another embodiment, the third party retailer is the retailer client 602 and provides the product information to the transaction facilitation service provider 106 from its own retailer-client product database 604. The transaction facilitation service provider uses the data collection component 610 to compile statistics, for example those collected from customer-clients 104 related to a series of the retailer-client's 602 products. The transaction facilitation service provider 106 provides analytic services and content 606 to the retailer-client 602. The transaction facilitation service provider 106, in one embodiment, provides the retailer-client 602 with an individualized watchlist button through the watchlist button code component 608.

When a potential purchaser of the retailer client 602 interacts with the customized watchlist button, provided from the watchlist button code component 608 on the third party retailer's website 110, their interaction is stored in the client data storage component 124 of the transaction facilitation service provider 106. In one embodiment, the potential purchaser is not already an existing customer-client 104 of the transaction facilitation service provider 106. The customer client data stored in the client data storage component 124 supports the analytic services and content 606 provided by the transaction facilitation service provider 106 to the third party retailer. In this embodiment, the potential purchaser interacts directly with the retailer client's 602 website, and does not directly interact with the transaction facilitation service provider 106. However, the transaction facilitation service provider 106 does provide the necessary functionality to support the watchlist button and provides analytics based on the information obtained from potential purchaser's interacting with the watchlist button. In an additional embodiment, the potential purchaser is also a customer-client 104 of the transaction facilitation service provider 106.

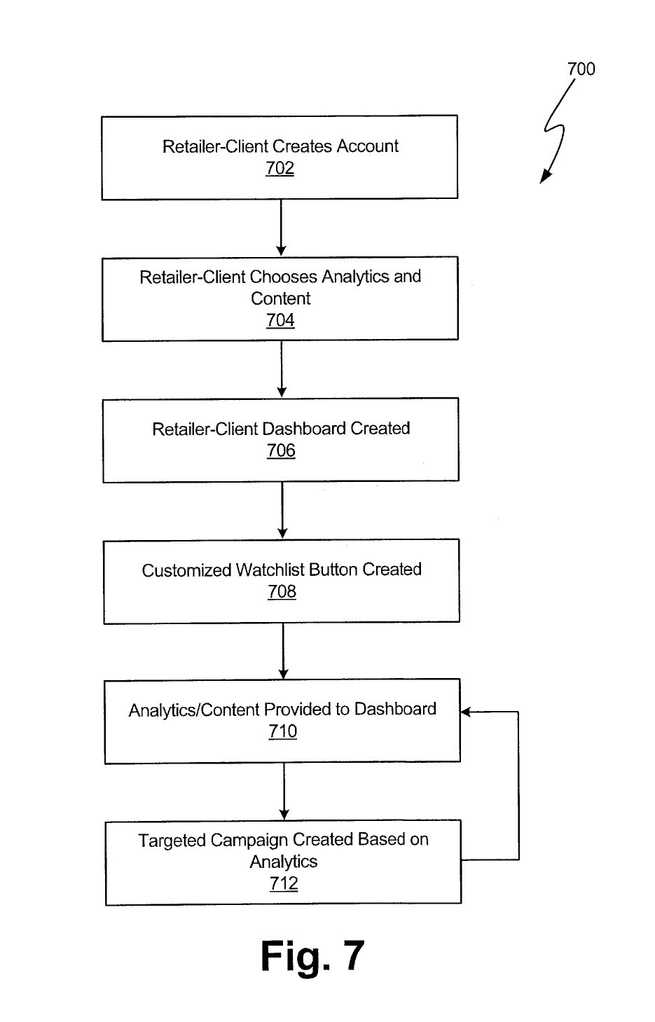

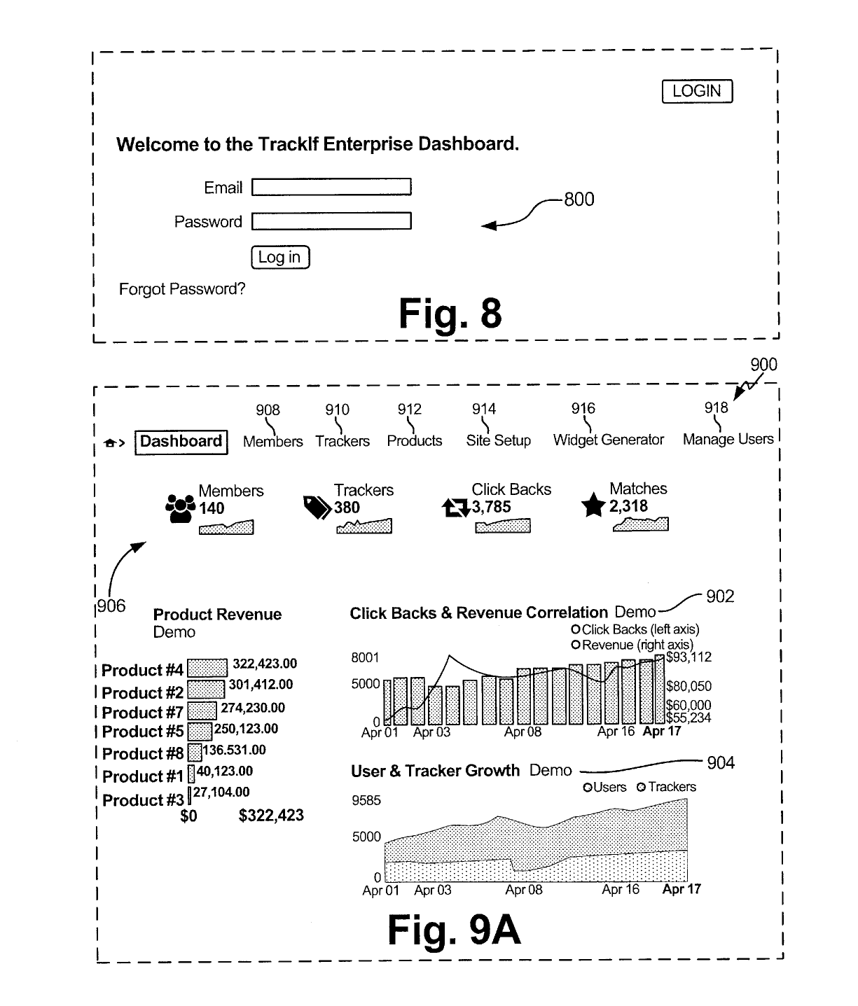

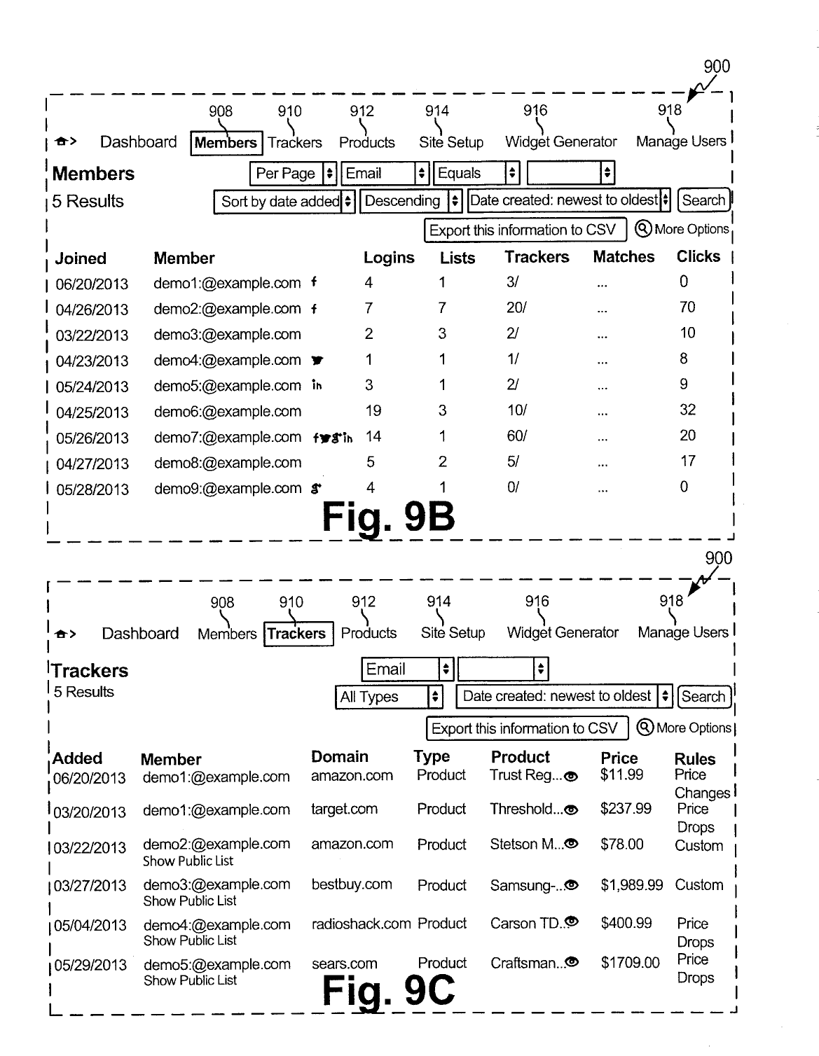

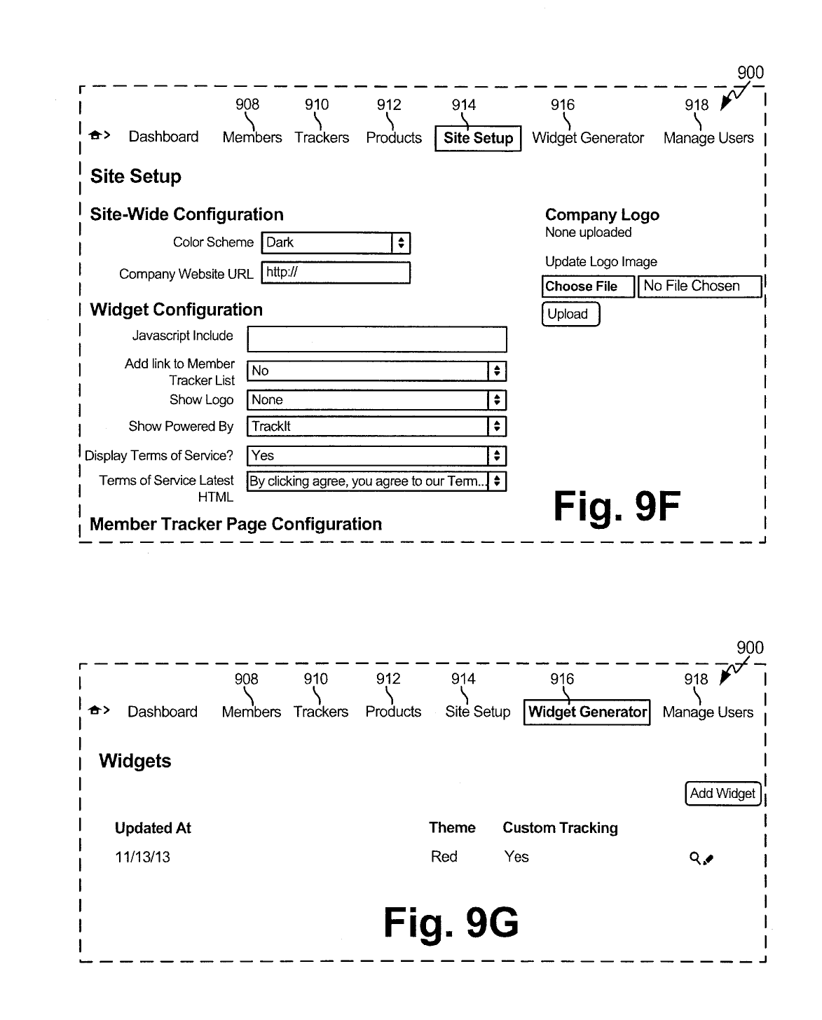

FIG. 7 illustrates one embodiment of how a retailer client 602 obtains analytics from the transaction facilitation service provider 106. The retailer client 602 starts, in block 702 by creating an account with the transaction facilitation service provider 106. In one embodiment, the retailer client 602 pays for analytics services and content based on a rate determined by a percentage of profits or revenue obtained from sales facilitated through the transaction facilitation service provider 106. In another embodiment, the retailer client 602 pays for analytics services and content based on a number of users that will access the analytic services and content. In still another embodiment, a combination of these subscription models is used. After creating an account, the retailer client 602 chooses the analytical services and content desired in block 704. An exemplary set of selected analytics is shown in FIG. 9 and discussed in greater detail below. The specifications concerning products sold by the retailer client 602 is, in one embodiment, already populated into the transaction facilitation service provider's database 120 in the third party retailer product information storage component 114. In block 706, the transaction facilitation service provider 106 creates a customized dashboard for the retailer-client 602 based on the analytics and content chosen in block 704. The transaction facilitation service provider 106 may also create a customized watchlist button in block 708. After creating the dashboard, the transaction facilitation service provider 106 populates the dashboard in block 710. Finally, with the analytics provided, the transaction facilitation service provider 106 assists the retailer-client 602 in creating a customized advertising campaign in block 712.

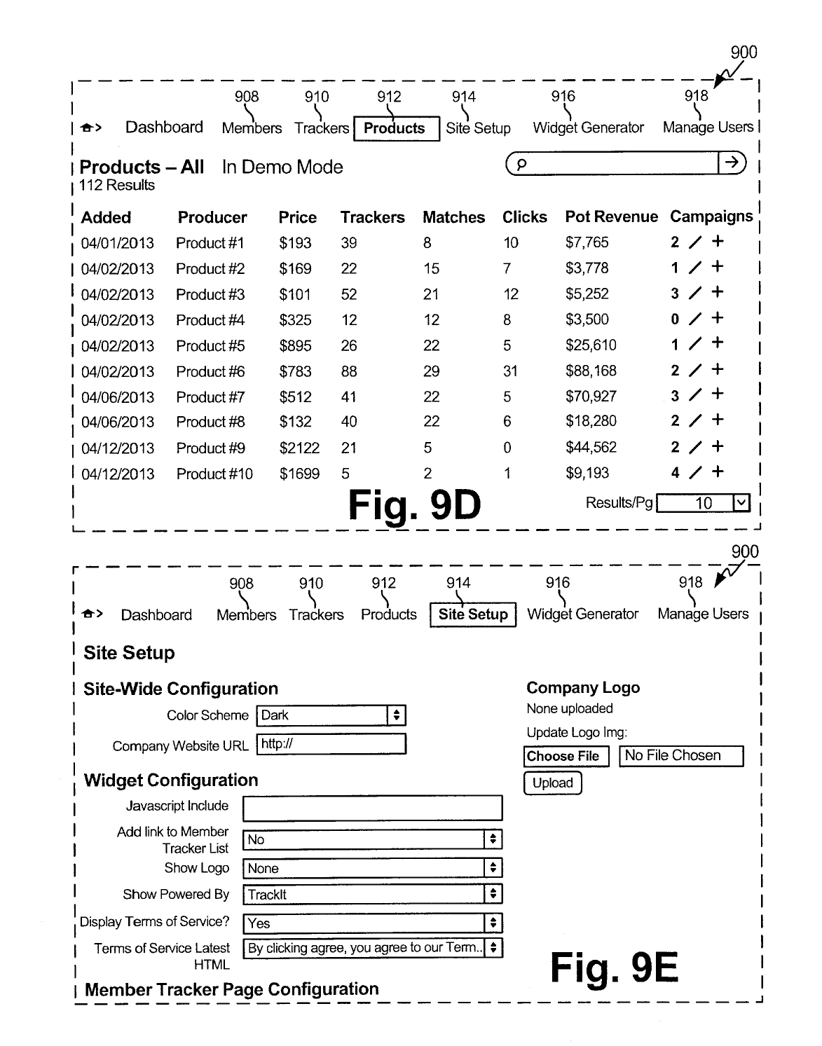

The retailer client 602's product information, and related analytics, are presented to the retailer client 602 on a platform hosted by the transaction facilitation service provider 106. In one embodiment, the platform is a dashboard hosted on a website as shown in FIG. 9. In an additional embodiment, the retailer client 602 must login to the website using a user-specific username and password, as shown in FIG. 8.

Analytical services and content are presented to the retailer client 602 in a dashboard shown in FIGS. 9A-G. FIG. 9A shows a homepage 900 of the dashboard, that includes statistics on click-backs and related revenue 902 generated as well information on user growth over time 904. Additionally, the dashboard homepage 900 shows general statistics 906 related to the retailer-client 602.

The dashboard includes, in one embodiment, a number of customer-clients 104, conditions set, click-backs and revenue 902 generated as a result of the alerts, and product matches. The dashboard further includes, in another embodiment, a depiction of revenue generated as a result of click-backs related to conditions set by customer-clients 104. In a preferred embodiment, the analytics are presented graphically. Additionally, the dashboard illustratively includes a breakdown of revenue generated by product of interest. The dashboard illustratively also breaks down the number of potential purchasers using the watchlist button by those that are customer-clients 104 of the transaction facilitation service provider 106 and those that are not.

Detailed information on the customer-clients 104 tracking products of the retailer client 602 is illustratively provided as part of the analytical services, on a member page 908 as shown in FIG. 9B. The information provided on each of the customer-clients 104 includes, illustratively in one embodiment, the date the customer-client 104 first signed up with the transaction facilitation service provider 106. The information provided also includes, illustratively, a customer-identifier, which is an e-mail address in a preferred embodiment, but could also be a customer-client 104 selected username or a transaction facilitation service provider 106 generated identification number. The dashboard may also include a number of times logged into the transaction facilitation service provider's 106 customer-client platform, a number of lists maintained by each customer-client 104, a number of conditions set by a customer client 104, and a number of click-backs to the third party retailer website 110 as a result of the watchlist. In a preferred embodiment, the retailer client 602 can search or sort through the list of customer-clients 104 by any of these data points. Some or all of this information may be presented to a retailer client 602 based on the subscription model selected by the retailer client 602.

FIG. 9C shows another exemplary embodiment of analytics that can be presented to a retailer client 602: analytics around the current conditions set by customer-clients 104 of the transaction facilitation service provider 106. In this exemplary embodiment, the trackers dashboard page 910 presents information including the date the condition for the notification on the product of interest was set, and who set the condition for notification. Additionally, the name of the third party website 110 where the product of interest was found by the customer-client 104 is also illustratively presented in FIG. 9C. The type of condition and the name of the product may also illustratively be presented to the user in the dashboard. The trackers dashboard page 910 also illustratively presents the current price of the product of interest and the condition set by the customer-client 104. While FIG. 9C shows only the price and the specific notification relative to the price in the dashboard, one skilled in the art would understand that the dashboard could also display the other conditions for notification, including shipping or sale conditions on products. In one embodiment, all of the information present in trackers dashboard page 910 is searchable and sortable as desired by the retailer client 602. For example, a retailer client 602 could sort to display only conditions set relative to the products displayed on their website. In another example, a retailer client 602 could sort specific to a competitor's set of products. In a further embodiment, the retailer client 602 can export the information from the transaction facilitation service provider's 106 platform to another format of their choosing.

FIG. 9D depicts another page of analytics presented to a retailer client 602 in an illustrative embodiment, an analytics page dedicated to the specific products sold by a particular retailer client 602, a product dashboard page 912. In an exemplary embodiment, the product dashboard page 912 details the date the product was added to the third party retailer product information storage component 114. The product dashboard page 912 also details the product name and the current price. The product dashboard page 912 also illustratively states the number of conditions set by customer-clients 104 on the product and the number of matches. The product dashboard page 912 also lists the number of clicks generated for the product where clicks generated include customer-client 104 selections to purchase as indicated in FIG. 4.

Using the platform hosted by the transaction facilitation service provider, the retailer client 602 can create a custom watchlist button for their website for customer-clients 104 and potential purchasers to interact with, as an alternative to the plug-in solution discussed previously. As shown in FIG. 9E, in one embodiment, the retailer client 602 can customize the button to match their website scheme or color combination on the button setup page 914 on the dashboard. In a preferred embodiment, the retailer client 602 can choose a color scheme and match the button to their logo. The retailer client 602 can also customize the properties of the button in another embodiment, choosing whether or not to show that the button is supported by the transaction facilitation service provider 106 as well as choosing whether or not to display the retailer client 602's terms of services. The retailer client 602 can sort and update the buttons created, as shown in FIG. 9F. As shown in FIG. 9G, the retailer client 602 can also have, as part of their subscription service, the transaction facilitation service provider 106 provide custom tracking for the watchlist button. The retailer client 602 can create different trackers and view the generated statistics on the tracking generator page 916.

Although the present invention has been described with reference to preferred embodiments, workers skilled in the art will recognize that changes may be made in form and detail without departing from the spirit and scope of the invention.

What is claimed is:

1. A method for receiving information about the intent of a user, implemented on a computer with a processor, the method comprising:
providing a user interface for the user to select a product of interest;
matching the selected product of interest to a product information set stored in a database;
offering the user at least one condition to set regarding an aspect of the product of interest;
adding the product of interest to a watchlist of products for future tracking;
receiving, with the processor, an indication that the condition has been met; and
providing a notification that the condition has been met.

2. The method of claim 1, wherein the aspect comprises the price of the product of interest.

3. The method of claim 2, wherein the condition comprises the price decreasing.

4. The method of claim 2, wherein the condition comprises a price decreasing below a threshold set by the user.

5. The method of claim 1, wherein the condition comprises free shipping of the product of interest.

6. The method of claim 1, wherein the at least one condition comprises a first condition and a second condition and wherein both the first condition and the second condition must be met before a notification is provided.

7. The method of claim 1, wherein the notification is an e-mail.

8. The method of claim 1, wherein the notification further comprises providing the user an opportunity to purchase the product of interest.

9. A method for providing analytics to a retailer, implemented on a computer with a processor, the method comprising:
storing a set of product information
providing a user interface for a plurality of users to indicate an interest in a product, wherein the indication of interest includes a condition for notification;
collecting the indications of interest in a database;
processing the indications of interest to sort the indications of interest by at least one of product type and type of notification; and
generating an advertising campaign based on the indications of interest.

10. The method of claim 9, wherein the indication of interest comprises a desire for free shipping.

11. The method of claim 9, wherein the indication of interest comprises a desire for a price decrease.

12. The method of claim 9, wherein the indication of interest comprises a desire for a price of the product to decrease below a set threshold.

13. The method of claim 9, wherein the indication of interest comprises a desire for the item to be back in stock.

14. The method of claim 9, wherein the advertising campaign at least provides at least one of the plurality of users with a reminder to purchase the product.

15. The method of claim 9, wherein the advertising campaign at least provides at least one of the plurality of users with a coupon based on the indication of interest in the product.

16. A tool for tracking user intent in an online retail environment, implemented on a computer-readable medium with a processor, the tool comprising:
a browser connected to a network, wherein the browser accesses a product on a website of an online retailer;
a database of a plurality of product identfiers and a plurality of retailer identifiers;
a browser plug-in, wherein the browser plug-in further comprises:
a product identifier that utilizes the processor to identify the product on the website of an online retailer;
a searching component that searches the database for the product identifier matching the product;
a notification component that presents the user with a plurality of conditions for a future notification regarding the product.
a watchlist that stores the conditions for a future notifications along with the product identifier; and
a notification generator that generates a notification to the user when the conditions set on the product have been met.

17. The tool of claim 16, wherein the notification is sent when only one of the conditions is met.

18. The tool of claim 16, wherein the notification is sent only when all of the conditions are met.

19. The tool of claim 16, wherein the conditions comprise at least an indication of a decrease in a price of the product.

20. The tool of claim 16, wherein the conditions comprises at least an indication of free shipping of the product.
